(19) United States
(12) Patent Application Publication
(10) Pub. No.: US 2006/0098666 A1
(43) Pub. Date: May 11, 2006

(54) Portable device configuration system

(76) Inventor: Justin Mark Francis Conde Powell, Danvers, MA (US)

Correspondence Address: JACK SCHWARTZ & ASSOCIATES, 1350 BROADWAY, SUITE 1510, NEW YORK, NY, 10018, US

(21) Appl. No.: 11/257,497

(22) Filed: Oct. 24, 2005

Related U.S. Application Data
(60) Provisional application No. 60/621,809, filed on Oct. 25, 2004.

(51) Int. Cl. H04L 12/56; H04L 12/413; H04L 12/28

(52) U.S. Cl. 370/401; 370/445

(57) ABSTRACT

A system for communicating a parameter from a first device to a second device includes an input processor for receiving data indicating a parameter. An interface processor, used by the first device, communicates a first message to the second device including data identifying a communication protocol to be used in communicating with the first device, This message also indicates that additional data is available for acquisition. The interface processor communicates the parameter to the second device in one or more separate messages in response to one or more corresponding data request messages from the second device. The data request messages are initiated by the second device in response to data being received from the first device indicating that additional data is available for acquisition. In response to receiving data indicating that the parameter has been acquired by said second device, the interface processor updates the message data for communication to the second device to indicate additional data is unavailable for acquisition.

### CROSS-REFERENCED TO RELATED APPLICATION

This is a non-provisional application of U.S. Provisional Application Ser. No. 60/621,809 filed Oct. 25, 2004.

### FIELD OF THE INVENTION

The present invention relates to a system for exchanging configuration data with a portable device, and in particular for exchanging communications configuration data with a portable device upon initial connection of the portable device to the system.

### BACKGROUND OF THE INVENTION

Portable devices are able to perform operations while remaining unconnected to other devices. Such portable devices are often physically connectable to a base system via a receptacle, termed a dock or holster. In many cases, the base system includes a communications network of interconnected nodes, such as a local area network (LAN) and/or a wide area network (WAN) e.g. the internet, to which the receptacle is connected. When the portable device is connected to the receptacle, termed docked, a communications channel is established to enable the portable device to communicate with the communications network via the receptacle. In order to minimize communications overhead, the portable device is configured to operate as a node on the communications network, and the receptacle is configured to act as a conduit for passing, but not processing, messages between the portable device and the communications network.

The communications protocol typically used for the communications network is the Ethernet protocol. Several versions of this protocol exist in current practical implementations (e.g. 10 Mbps such as 10Base2, 10BaseT and 10BaseF; 100 MBps; Gigabit, etc.). In addition, Ethernet protocols are available for both wired and wireless communications links. As added speed and features become available, it is expected that further versions will become available in the future. Different versions may not be used over the same communications link simultaneously. Thus, new equipment attached to an existing system must be configured to use the same Ethernet version as the equipment to which it is attached.

Networking equipment has been developed which can support different versions, e.g. 10 Mbps, 100 Mbps and 1000 Mbps, and can operate with communications networks using any of the supported Ethernet versions, including wired or wireless.

### BRIEF SUMMARY OF THE INVENTION

A procedure has been developed to automatically determine the capabilities of newly connected networking equipment and to concurrently broadcast the capabilities of the networking equipment to which the new equipment is attached. An automatic negotiation of the highest capability version which both pieces of networking equipment support is performed. Such a procedure is termed auto-negotiation as defined by Clause 28 of the D4 draft of the ANSI/IEEE Std 802.3 MAC Parameters, Physical Layer, Medium Attachment Units and Repeater for 100 Mb/s Operation.

Existing solutions provide circuitry to transmit a unique identifier, termed a media access control (MAC) address in Ethernet communications networks, from the receptacle to the portable device. However, such circuitry adds cost, complexity, and size to such equipment, increases power dissipation and decreases reliability. A system according to invention principles addresses these deficiencies and related problems.

The inventor advantageously realized that the Ethernet auto-negotiation process provides for transferring information between a communications network and a newly connected node in addition to negotiating the communications protocol, e.g. Ethernet version, to be used on that link. In this manner, parameters may be transferred between equipment connected to the network and newly connected equipment before network communications is initiated.

In accordance with principles of the present invention, a system for communicating a parameter from a first device to a second device includes an input processor for receiving data indicating a parameter. An interface processor, used by the first device, communicates a first message to the second device including data identifying a communication protocol to be used in communicating with the first device, This message also indicates that additional data is available for acquisition. The interface processor communicates the parameter to the second device in one or more separate messages in response to one or more corresponding data request messages from the second device. The data request messages are initiated by the second device in response to data being received from the first device indicating that additional data is available for acquisition. In response to receiving data indicating that the parameter has been acquired by the second device, the interface processor updates the message data for communication to the second device to indicate additional data is unavailable for acquisition.

A system according to principles of the present invention may transfer a unique identifier, for example an identifier necessary to uniquely identify a node on a network, such as a Ethernet MAC address, from a receptacle to a portable device using the auto-negotiation process before network communications is initiated.

### BRIEF DESCRIPTION OF THE DRAWING

In the drawing:

FIG. 1 is a block diagram of a portable device configuration system according to principles of the present invention;

FIG. 2 is a more detailed block diagram of an interface processor which may be used in the system illustrated in FIG. 1 according to principles of the present invention;

FIG. 3 is a flow chart useful in understanding the operation of the system illustrated in FIG. 1 and FIG. 2 according to principles of the present invention; and

FIG. 4 is a block diagram of a computer system on which the portable device configuration system illustrated in FIG. 1 and FIG. 2 according to principles of the present invention may be implemented.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, portable device configuration system or other information processing system, for example, in response user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

One environment in which portable devices find use is in a medical environment such as a hospital. Physiological parameters (i.e. heart rate, blood pressure, SpO₂, EKG, respiration, etc.) of patients are typically monitored in a hospital environment. For some acutely ill patients, such monitoring is continual with a relatively short sampling interval, even as the patient is transported from one location in the hospital to another. Portable patient monitors have been developed which may remain with the patient. Such portable patient monitors are typically battery powered and are capable of monitoring physiological parameters, displaying them for attending clinicians, and saving the results for later review.

However, hospitals also maintain central locations, connected to a hospital communications network, where patient physiological parameters may be monitored and/or stored over the length of the patient's stay. Such hospitals have receptacles, termed docking stations or holsters, for portable patient monitors at fixed locations, such as patient rooms, therapy rooms, operating rooms, etc. These receptacles are connected to the hospital communications network. When the patient is in one of those locations, the portable patient monitor may be placed in the receptacle. While in the receptacle, the batteries in the patient monitor are recharged and the patient monitor is connected to the hospital communications network. Any physiological parameters gathered while the portable patient monitor is not connected to the communications network may be transmitted to the central location for storage and physiological parameters sampled while the portable patient monitor is inserted in the receptacle may be sent to the central location as they are gathered.

As described above, when a portable patient monitor is docked to a docking station, a communications channel is established between the docked portable patient monitor and the hospital communications network. In this communications channel, the portable patient monitor operates as a network node and the docking station operates as a repeater. Also as described above, this requires that a unique identifier be transferred from the docking station to the portable patient monitor before communications may be initiated between the portable patient monitor and the hospital communications network. Because the unique identifier is associated with the docking station, this also advantageously enables determination of the geographic location of the particular docking station from a map, maintained at the central location, associating the unique identifier with the corresponding geographic location of the docking station.

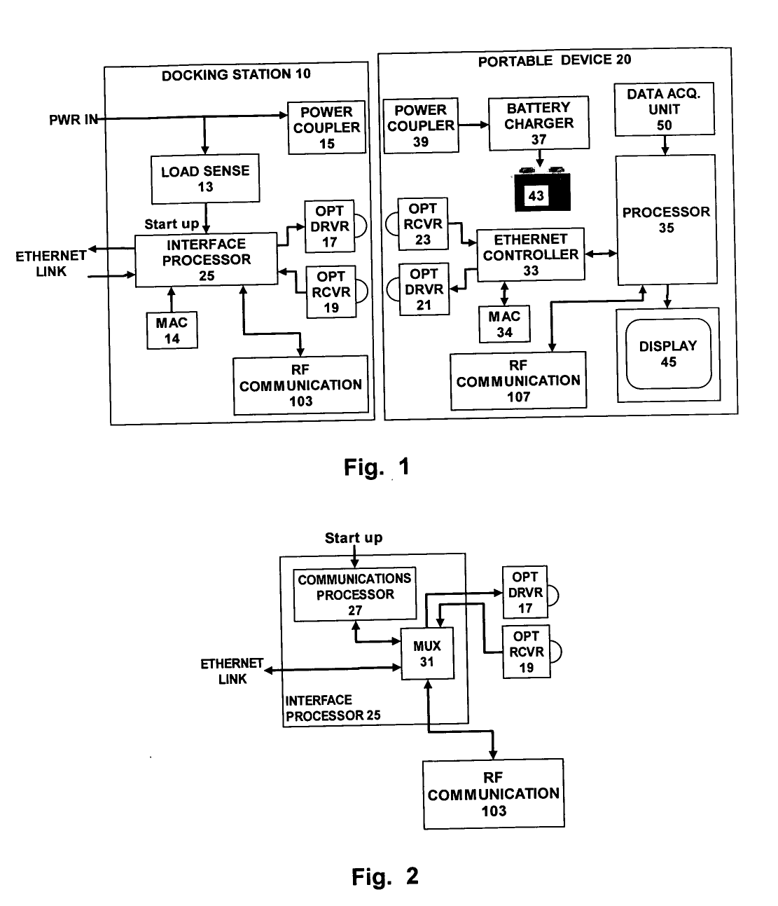

FIG. 1 is a block diagram of a portable device configuration system according to principles of the present invention. In FIG. 1, a docking station 10 includes power input terminal coupled to a source of electrical power (not shown). The power input terminal is coupled to respective input terminals of a load sense circuit 13 and a power coupler 15. The docking station 10 also includes a bidirectional terminal coupled to an Ethernet link to the hospital communications system (also not shown). The Ethernet link bidirectional terminal is coupled to respective corresponding bidirectional terminals of an interface processor 25. A second bidirectional terminal of the interface processor 25 is coupled an optical communications link. More specifically, an output terminal of the interface processor 25 is coupled to an optical driver 17 and an input terminal of the interface processor 25 is coupled to an optical receiver 19. A first control input terminal, receiving a “Start up” signal, is coupled to an output terminal of a load sense circuit 13. A second control input terminal is coupled to a source 14 of a unique identifier.

A portable device 20 includes a power coupler 39. An output terminal of the power coupler 39 is coupled to an input terminal of a battery charger 37. An output terminal of the battery charger 37 is coupled to a battery 43. The portable device 20 also includes a processor 35. An output terminal of a data acquisition unit 50 is coupled to an input terminal of the processor 35. An output terminal of the processor is coupled to a display device 45. A first bidirectional terminal of the processor 35 is coupled to a corresponding terminal of an Ethernet controller 33. A second bidirectional terminal of the Ethernet controller 33 is coupled to an optical link. More specifically, an output terminal of the Ethernet controller 33 is coupled to an optical driver 21 and an input terminal of the Ethernet controller 33 is coupled to an optical receiver 23. A second bidirectional terminal of the processor 35 is coupled to an RF communications circuit 107. A bidirectional control terminal of the Ethernet controller 33 is coupled to a store 34 containing a unique identifier.

In operation, when the portable device 20 is undocked, the battery 43 provides the power to the portable device 20. In a medical environment, the portable device is a portable patient monitor. In a portable patient monitor, the data acquisition unit 50 is coupled to sensors (not shown) attached to the patient, and/or to patient monitoring and/or treatment devices operating on the patient. The data acquisition unit 50 processes patient parameter data such as physiological data including (a) electro-cardiograph (ECG) data, (b) blood parameter data, (c) ventilation parameter data, (d) infusion pump related data, (e) blood pressure data, (f) pulse rate data, (g) temperature data, and other similar patient parameter data. The processor 35 generates signals representing images for displaying the patient physiological parameter data. These image representative signals are supplied to the display device 45 which displays the image representing the patient physiological parameter data for the clinician. In addition, the processor 35 may include memory (not shown) for storing the patient physiological parameter data. The patient physiological parameter data may also be transmitted from the processor 35 to the hospital communications network via access points connected via the RF communications link 107.

When the portable device 20 is inserted into the docking station 10, i.e. docked, as illustrated in FIG. 1, the interface processor 25 initiates a first mode of operation to establish communications between the portable device 20 and the hospital communications network, in a manner to be described in more detail below. In this mode of operation, as described above, it is necessary to communicate the unique identifier of the docking station 10 to the portable device 20. This is done using the Ethernet compatible auto-negotiation process. The auto-negotiation process identifies a communications protocol acceptable to both the docking station and the portable device, and also communicates the docking station 10 unique identifier to the portable device 20.

When the first mode of operation is completed, the interface processor 25 in the docking station subsequently initiates operation in a second mode of operation establishing a connection between the portable device 20 and the hospital communications network using the acceptable communications protocol. In this mode of operation, the interface processor 25 initiates communications between the portable device 20 and the docking station 10. The interface processor 25 may communicate by either (i) wireless and (ii) wired communication. More specifically, in the illustrated embodiment, after the unique identifier has been communicated from the docking station 10 to the portable device 20, the interface processor 25 in the docking station 10 may communicate with the portable device 20 using the optical link 17, 19, 21, 23, and/or using the RF communication circuits 103 and 107. One skilled in the art understands that any RF wireless technology may be used to implement the RF wireless link, such as (a) WLAN 802.11b standard compatible communication, (b) 802.3 standard compatible communication, (c) 802.11 standard compatible communication, (d) Bluetooth 802.15 standard compatible communication, and (e) GSM/GPRS standard compatible communication.

When operating in the second mode of operation, the docking station operates as a repeater, passing data between the portable device 20 and the hospital communications network without processing it. Patient parameter data gathered when the portable device 20 was undocked is downloaded to the hospital communications network for storage in the central location. Similarly, patient parameter data gathered while the portable device 20 is docked is sent immediately to the central location via the hospital communications network.

FIG. 2 is a more detailed block diagram of an interface processor 25 which may be used in the system illustrated in FIG. 1. In FIG. 2, the “Start up” signal from the load sense circuit 13 (FIG. 1) is coupled to an input terminal of a communications processor 27. A bidirectional terminal of the communications processor 27 is coupled to a first bidirectional terminal of a multiplexer 31. The Ethernet link to the hospital communications system is coupled to a second selectable terminal of the multiplexer 31. A second bidirectional terminal of the multiplexer 31 is coupled to the optical link. That is, an output terminal of the multiplexer 31 is coupled to the optical driver 17 and an input terminal of the multiplexer 31 is coupled to the optical receiver 19. A third bidirectional terminal of the multiplexer is coupled to the RF communications circuit 103

In operation, the “Start up” signal indicates that the portable device 20 is newly docked to the docking station 10. This signal conditions the communications processor 27 to initiate the first mode of operation. During the first mode of operation, the multiplexer 31 is conditioned to connect the communications processor 27 to the optical driver 17 and optical receiver 19. During the second mode of operation, the multiplexer 31 is conditioned to couple the Ethernet link to the hospital communications network to either the optical link, e.g. the optical driver 17 and optical receiver 19, or to the RF link, e.g. the RF communications circuit 103, depending on which mode of communications is being used. In this way, the docking station 10 is configured to operate as a repeater during the second mode of operation.

Referring again to FIG. 1, when the portable device 20 is docked, power is coupled from the docking station 10 to the portable device 20 via the power couplers 15 and 39. In the illustrated embodiment, the power couplers 15 and 39 form a split transformer. The primary is in the power coupler 15 in the docking station 10 which is magnetically coupled to the secondary in the power coupler 39 in the portable device 20. When docked, power is coupled to the portable device 20 via the transformer formed by the power couplers 15 and 39. This power is supplied to the battery charger 37, which, in turn, charges the battery 43.

The interface processor 25 may detect that the portable device 20 is attached to the docking station 10 by detecting (a) an active communication link between the portable device 20 and the hospital communications network, (b) an active communication link between the docking station 10 and the portable processing device 20, and/or (c) that the portable device 20 is docked with the docking station 10 and is receiving electrical power from the docking station 10. For example, the presence of the portable device 20 may be detected by the docking station 10 by the load sense circuit 13. When the portable device 20 is undocked, the power coupler 15 in the docking station is a primary winding without a secondary winding and exhibits a relatively higher voltage in response. The load sense circuit 13 can detect the high voltage condition indicating that the portable device is undocked. When the portable device 20 is docked, the power couplers 15 and 39 form a complete transformer. The relatively higher voltage condition on the power coupler 15 is removed. This is detected by the load sense circuit 13, which generates a “Start up” signal. The “Start up” signal is coupled to the interface processor 25.

When the presence of the portable device 20 is detected by the docking station 10, the docking station 10 initiates the process of connecting the processor 35 in the portable device to the hospital communications network via the Ethernet controller 33, e.g. the first mode of operation described above. This process uses the Ethernet auto-negotiation process. In general, auto-negotiation involves the exchange of messages between a first device such at the docking station 10, termed a local device (LD), and another device such as the portable device, termed a link partner (LP). In Messages are formed of 16 bit link code words (LCW). The 16 bits of the LCWs are interleaved between 17 clock bits in a predetermined manner termed FM pulse encoding, and the resulting pulse stream is transmitted on the output link terminal at a predetermined pulse rate (12.5 KHz) and repeated at a predetermined repetition rate (16.8 ms). Concurrently, LCWs from the other device are received on the input link terminal.

One bit of the 16 bit LCW, e.g. bit D14, has a value (Ack) used to acknowledge of successful receipt of an LCW from the link partner; and another bit, e.g. bit D15, has a value, termed NP for “Next Page”, used for indicating that addition data is available for acquisition by the link partner. This is illustrated in Table 1 (below). The remaining bits (D0 through D13) are assigned to carry different data depending on the type of data being exchanged: i.e. auto-negotiation of an acceptable communications protocol, or exchange of additional data. The encoding of the LCW, the bit rate, the repetition rate, and the values assigned to the remaining bits in the LCW are standardized and are not described in detail below. In the remaining description LCW[LD] will represent an LCW transmitted from a local device (e.g. docking station 10) and LCW[LP] will represent an LCW received from the link partner (e.g. portable device 20). To exchange a message, LCWs are continually transmitted at the predetermined repetition rate according to the process below.

TABLE 1

| | | | | | | | | | | | | | | | |
|---|---|---|---|---|---|---|---|---|---|---|---|---|---|---|---|
| D0 | D1 | D2 | D3 | D4 | D5 | D6 | D7 | D8 | D9 | D10 | D11 | D12 | D13 | D14 | D15 |

| | |
|---|---|
| Ack | NP |

Messages are exchanged in the following manner during auto-negotiation. Both the local device (e.g. docking station 10) and the link partner (e.g. portable device 20) generate respective LCWs encoding desired data in an appropriate manner. For example, during the first mode of operation, the communications protocols available in the docking station are encoded in the LCW[LD] and the communications protocols available in the portable device 20 are encoded in the LCW[LP]. During the second mode of operation, at least a portion of the unique identifier, such as the MAC address of the docking station 10, is encoded in the LCW[LD].

To exchange a message, the local device begins by repetitively transmitting its LCW[LD], carrying the desired data, with the Ack bit not set. Once three consecutive matching, LCW[LP]s are received from the link partner (ignoring Ack), the local device sets the Ack bit in the transmitted LCW[LD] to indicate to the link partner that it has received the link partner's LCW[LP] correctly and continues to repetitively transmit that LCW[LD]. Upon receiving three consecutive matching LCW[LP]s with the Ack bit set, the local device knows that the link partner has received the local device's LCW[LD] correctly. The local device transmits the Link Code Word with the Ack bit set 6 to 8 additional times to ensure that a complete message exchange has taken place. This process occurs whenever a message is exchanged as described below.

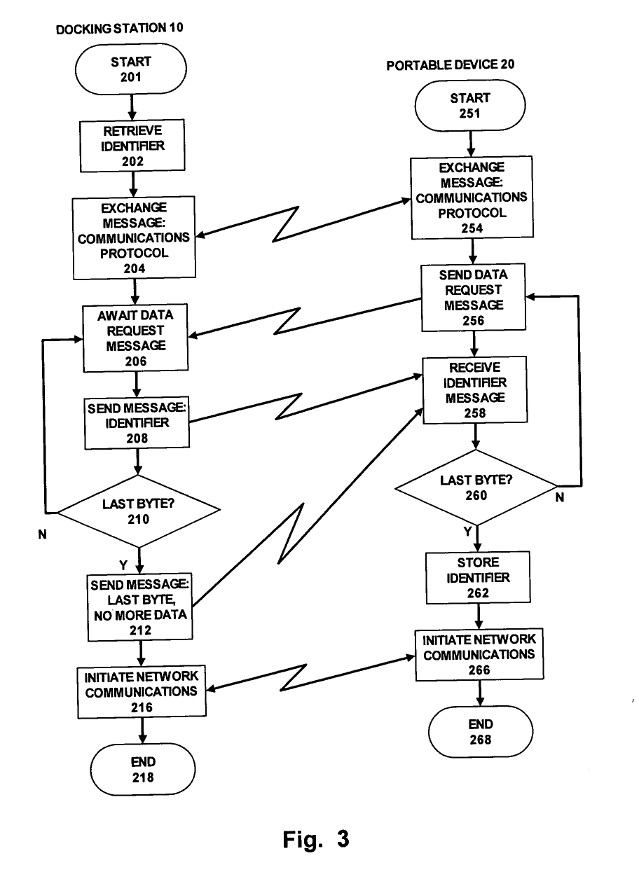

FIG. 3 is a flow chart useful in understanding the operation of the system illustrated in FIG. 1 and FIG. 2. In FIG. 3, the flow chart on the left hand side represents activities in the docking station 10 (FIG. 1) and the flow chart on the right side represents activities in the portable device 20. With respect to communicating the unique identifier, the portable device 20 operates as a master and the docking station 10 operates as a slave, in a manner to be described in more detail below.

Referring to both FIG. 1 and FIG. 3, the process begins in the docking station 10 at step 201 and in the portable device 20 in step 251. In step 202, the interface processor 25 in the docking station 10 retrieves a parameter, from the source 14. In the illustrated embodiment, the parameter is a unique identifier or electronic address unique to the particular docking station 10. In the illustrated embodiment, the electronic address is a media access control (MAC) identifier. However, one skilled in the art understands that the electronic address associated with the particular docking station 10 may comprises (a) an Ethernet compatible MAC address, (b) an IP address, (c) a port identifier, (d) an Internet compatible address, (e) a LAN address, or any other similar electronic address which may uniquely identify the particular docking station 10.

In steps 204 and 254, the first mode of operation is performed. LCWs are exchanged, in the manner described above, containing data representing the available communications protocols in the docking station 10 and the portable device 20. A known procedure selects a common communications protocol. In this case, the NP bit is set in the LCW[LD]. Setting the NP bit indicates that additional data is available for acquisition by the portable device 20. In response, the portable device 20 sets the NP bit in the LCW[LP]. As set forth in the auto-negotiation standard defined by Clause 28 of the D4 draft of the ANSI/IEEE Std 802.3 MAC Parameters, Physical Layer, Medium Attachment Units and Repeater for 100 Mb/s Operation, when the NP bit is set, before communications is initiated using the common communications protocol, additional data is exchanged using the same method for exchanging messages between the docking station 10 and the portable device 20. The remainder of the activities illustrated in FIG. 3 comprise the second mode of operation.

In step 256, a data request message is sent from the portable device 20 to the docking station 10. The data request message is encoded as the LCW[LP] with the Ack bit set and with the NP bit set. This indicates that the previous communications protocol data from the docking station 10 was received properly by the portable device 20, and that the portable device 20 is ready to receive additional data. In step 206, the data request message from the portable device is received at the docking station 10.

A MAC address contains 48 bits or 6 bytes. An LCW may convey up to 11 bits of additional data. In the illustrated embodiment, the MAC address is communicated from the docking station 10 to the portable device 20 eight bits or one byte at a time. That is, six messages, containing one byte of the MAC address, are sent from the docking station 10 to the portable device 20 to convey the complete MAC address. Table 2 (below) illustrates the structure of the LCW messages carrying the MAC address. Bits D0 through D7 carry a byte of the MAC address M0 through M7. Bits D8 through D10 carry the number of the MAC address byte N0 through N2. Bytes 1 through 6 carry the corresponding byte of the MAC address and a byte 7 carries a CRC of the MAC address calculated using the polynomial X⁷+X²+1.

TABLE 2

| | | | | | | | | | | | | | | | |
|---|---|---|---|---|---|---|---|---|---|---|---|---|---|---|---|
| D0 | D1 | D2 | D3 | D4 | D5 | D6 | D7 | D8 | D9 | D10 | D11 | D12 | D13 | D14 | D15 |

| | | | | | | | | | | | | |
|---|---|---|---|---|---|---|---|---|---|---|---|---|
| M0 | M1 | M2 | M3 | M4 | M5 | M6 | M7 | N0 | N1 | N2 | Ack | NP |

In step 208, a first LCW[LD] is formatted as illustrated in Table 2 (above) by the interface processor 25 to contain the first byte of the MAC address and the byte number set to “1”. Because there will be further messages containing remaining bytes of the MAC address, the NP bit is set in the LCW[LD]. This message is communicated, in the manner described above, to the portable device 20. The message containing the first byte of the MAC address is received by the portable device 20 in step 258. The Ethernet controller 33 stores the received byte of the MAC address.

In step 260, the portable device 20 detects the state of the NP bit in the received LCW[LD]. If the NP bit is set, this indicates that other messages will be forthcoming. In this case, step 256 is repeated. In step 256, the acknowledgement LCW[LP] sent in response to the LCW[LD] containing the first byte of the MAC address has the Ack bit set, the NP bit set, and the byte number B0 through B3 set to “2”, thus forming a data request to receive the next message from the docking station 10 containing byte 2 of the MAC address. In step 210, the interface processor 25 in the docking station 10 checks whether more bytes of the MAC address remain to be communicated. If so, step 206 is repeated waiting for a data request message from the portable device 20. When such a data request message is received, step 208 is performed, in which an LCW[LD], containing the requested byte of the MAC address, and with the NP bit set, is composed and sent to the portable device 20. Steps 206, 208, 210 and 256, 258 and 260 are repeated to transfer the respective bytes of the MAC address and the CRC byte.

If in step 210 it is determined that the last byte of the MAC address parameter, the CRC, is to be communicated to the portable device 20, step 212 is performed. In step 212 the interface processor 25 in the docking station 10 composes an LCW[LD] containing the CRC byte of the MAC address with the NP bit not set. This indicates that no further data is available for acquisition by the portable device 20. In step 258, this message is received and the CRC byte is stored by the Ethernet controller 33. Because the NP bit was not set in the LCW[LD] received by the portable device 20, the acknowledgement LCW[LP] has the Ack bit set, but the NP bit unset. Because the NP bit in the LCW[LP] is not set, this is not a data request from the portable device 20, and indicates that the portable device 20 successfully acquired the full MAC address.

In this case, in step 260, the state of the NP bit indicates that no further messages are forthcoming, and in step 262 the six bytes of the MAC address are combined to form the MAC address, and that MAC address is stored in the MAC address store 34. In addition, the CRC received from the docking station 10 is compared to the CRC calculated from the MAC address stored in the address store 34. In steps 216 and 266, network communications is established between the portable device 20 and the hospital communications network. In the docking station 10, step 216 conditions the multiplexer 31 (FIG. 2) to couple the Ethernet link to the hospital communications network to either the optical link 17, 19 or the RF link 103. In the portable device 20, the Ethernet controller 33 initiates communications with the hospital communications network via the optical link 21, 23 or the RF link 107. As described above, the messages sent from the Ethernet controller 33 of the portable device 20 to the hospital communications network include the MAC address in 34 as the sending node identifier. The destination address of messages received by the Ethernet controller 33 in the portable device 20 from the hospital communications network are compared to the MAC address in 34 to determine if they are addressed to the portable device 20. If they are, the Ethernet controller 33 processes the received messages.

When communications has been established, it is possible for the portable device 20 to be undocked from the docking station 10. When this is detected, for example, by detecting a change in voltage on the primary winding of the split transformer 15, the multiplexer 31 couples the RF communications circuit 103 to the Ethernet link to the hospital communications network and the Ethernet controller 33 in the portable device 20 communicates through the RF communications circuit 107. Provided the portable device 20 remains within range of the docking station, the communications link between the portable device 20 and the hospital communications network is maintained. If the RF link is lost, the portable device 20 goes into undocked mode, described above.

If the portable device 20 is redocked without losing communications, the load sense circuit 13 may detect that the portable device has been redocked, but the presence of an active communications link to the hospital communications network, and/or the presence of an active communications link between the portable device 20 and the docking station 10 may be detected. Detection of these conditions will inhibit re-establishment of the communications link as described in detail above.

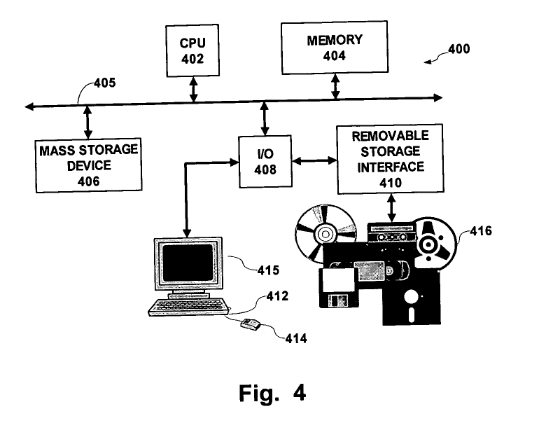

FIG. 4 is a block diagram of a computer system on which the portable device configuration system illustrated in FIG. 1 and FIG. 2 may be implemented. The processing system 400 includes a central processing unit (CPU) 402, a memory 404, a mass storage device 406, and an input/output (I/O) interface 408 coupled together by a computer bus 405. The I/O interface 408 is coupled to a user interface consisting of a monitor 415, a keyboard 412 and a pointing device, which in the illustrated embodiment is a mouse 414. The I/O interface 408 is also coupled to a removable storage interface 410 capable of retrieving data from or storing data on one or more tangible electronic data storage media 416. The tangible electronic data storage media 416 may include magnetic devices such as reel-to-reel computer tape, cassette tapes, and magnetic disk media such as floppy disks, and so forth. The tangible electronic data storage media 416 may also include optical devices, such as digital video disks (DVD) or compact disks (CD) and so forth. The tangible electronic data storage media 416 may also include portable storage devices such as semiconductor memory integrated circuits, e.g. memory sticks, and so forth. The I/O interface 408 may also be coupled to other peripheral devices (not shown) such as printers or communications devices for communicating with remote systems, local area networks (LANs) or wide area networks (WANs) such as the internet. One skilled in the art understands that the removable storage interface 410 may be coupled to the I/O interface 408 via a network interface (not shown), which allows the tangible electronic data storage media 416 to be located remote from the processing system 400.

In operation, the CPU 402 operates as a processor which executes the machine readable instructions forming an executable application and/or executable procedures. Those machine readable instructions are stored in the memory 404, which may consist of read-only memory (ROM) and/or read/write memory (RAM). The CPU 402 retrieves the machine readable instructions from the memory 404 and executes them to perform the operations of the system described above.

In the illustrated embodiment, the I/O processor 408 includes a display processor which, in response to commands from the CPU 402, generates signals representing a display image and supplies those image representative signals to the monitor 415 which displays the images. For example, in a docking station for a patient monitor, signals representing physiological parameters from a patient may be generated by the display processor. These image representative signals are supplied to the display device 415, which displays the image representing the physiological parameters. The I/O processor 408 also receives user commands and data from the keyboard 412 and/or mouse 414 and provides that information to the CPU 402. The CPU 402 responds to the received user commands and data to control the operation of the information acquisition system as described above.

Data may be retrieved from and stored in the mass storage device 406. For example, the mass storage device 406 may store data representing the machine readable instructions forming the executable application and/or executable procedures. The CPU 402 may retrieve the executable application and/or executable procedures from the mass storage device 406 and store them in the memory 404. The CPU 402 may retrieve the machine readable instructions from the memory 404 and execute the executable application and/or executable procedures to perform the activities described above.

Data may also be retrieved from and stored in tangible electronic data storage media 416 via the removable storage interface 410, whether local or remotely located. Any data may be stored in and/or retrieved from the tangible electronic data storage media 416. More specifically, in the illustrated embodiment, the machine readable instructions in the executable application and/or executable procedures forming the system described above may be stored in a tangible electronic data storage medium 416. The CPU 402 may condition the I/O processor 408 to retrieve the executable application and/or executable procedures from the appropriate tangible electronic data storage medium 416 via the removable storage interface 410, and to store the executable application and/or executable procedures in the mass storage device 406 and/or the memory 404. The CPU 402 may execute the executable application and/or executable procedures in the memory 404 to perform the activities described above.

The portable device configuration system has been described above in a medical environment relating to a portable patient monitor and docking station. However, such a system may find application in any system in which a new device may be added to a communications network intended to operate as a node through a repeater.

What is claimed is:

1. In a system for communicating a parameter from a first device to a second device, an interface processor comprising circuitry for:
communicating to said second device first message data identifying a communication protocol to be used in communicating with said first device and indicating additional data is available for acquisition;
receiving from said second device one or more data request messages initiated in response to data received from said first device indicating that additional data is available for acquisition;
communicating said parameter to said second device in one or more separate messages in response to said one or more corresponding data request messages from said second device;
receiving data indicating said parameter has been acquired by said second device; and
in response to receiving data indicating said parameter has been acquired by said second device, updating message data for communication to said second device to indicate additional data is unavailable for acquisition.

2. A system according to claim 1 further comprising circuitry for initiating communications between said first and second devices using said identified communications protocol after said parameter has been communicated from said first device to said second device.

3. A system for communicating a parameter from a first device to a second device, comprising:
an input processor for receiving data indicating a first device electronic address;
an interface processor used by said first device for:
communicating to said second device, first message data identifying a communication protocol to be used in communicating with said first device and indicating additional data is available for acquisition,
communicating said electronic address to said second device in one or more separate messages in response to one or more corresponding data request messages from said second device, said data request messages being initiated in response to data received from said first device indicating additional data is available for acquisition; and
in response to receiving data indicating said first device electronic address has been acquired by said second device, updating message data for communication to said second device to indicate additional data is unavailable for acquisition.

4. A system according to claim 3 wherein the interface processor initiates communications between said first and second devices using said identified communications protocol after said first device electronic address has been communicated from said first device to said second device.

5. A system according to claim 3 wherein:
said first device is a docking station suitable for attaching to a portable patient monitoring device;
said second device is a portable patient monitoring device; and
said interface processor communicates said electronic address from said docking station to said portable patient monitoring device using an Ethernet compatible auto-negotiation procedure.

6. A system according to claim 3 wherein said electronic address is an Ethernet compatible MAC address.

7. A system for use in a docking station suitable for attaching to a portable processing device, said portable processing device being for processing signal parameters, comprising:
a power coupler for coupling power to provide electrical power to a portable processing device; and
an interface processor for:
in a first mode of operation, communicating an identifier associated with a particular docking station to said portable processing device using an Ethernet compatible auto-negotiation procedure, and
in a second mode of operation, establishing connection of said portable processing device to a network.

8. A system according to claim 7 including a controller for detecting a portable processing device is attached to said docking station and for initiating said first mode of operation and for subsequently initiating said second mode of operation.

9. A system according to claim 7 wherein said controller detects said portable processing device is attached to said docking station by detecting at least one of, (a) an active communication link to said network is present, (b) an active communication link is present between said docking station and said portable processing device and (c) a portable patient monitoring device is docked with said docking station and receiving electrical power from said docking station.

10. A system according to claim 7 further comprising a controller for inhibiting said first mode of operation until said controller determines said portable processing device is attached to said docking station and is powered on.

11. A system according to claim 7 wherein said interface processor supports communication using wireless technologies including at least one of, (a) WLAN 802.11b standard compatible communication, (b) 802.3 standard compatible communication, (c) 802.11 standard compatible communication, (d) Bluetooth 802.15 standard compatible communication, and (e) GSM/GPRS standard compatible communication.

12. A system for use in docking station suitable for being attached to a portable patient monitoring device for monitoring and processing signal parameters acquired from a patient, comprising:
an communication interface employed by a docking station, for:
communicating to said portable patient monitoring device, first message data identifying a communication protocol to be used in communicating with said docking station and indicating additional data is available for acquisition,
communicating an electronic address associated with said docking station to said portable patient monitoring device in one or more separate messages in response to one or more corresponding data request messages from said portable patient monitoring device, said data request messages being initiated in response to data received from said docking station indicating additional data is available for acquisition, and
in response to receiving data indicating said docking station electronic address has been acquired by said portable patient monitoring device, communicating a message indicating address data communication is complete.

13. A system according to claim 12 wherein said communication interface communicates said electronic address to said portable patient monitoring device during bidirectional configuration data exchange in response to insertion of said portable patient monitoring device in said docking station.

14. A system according to claim 13 wherein said communication interface communicates said electronic address to said portable patient monitoring device during bidirectional configuration data exchange in response to a first insertion of said portable patient monitoring device in said docking station.

15. A method for communicating a parameter from a first device to a second device, comprising the activities of:
receiving data indicating a first device electronic address;
communicating to said second device, first message data identifying a communication protocol to be used in communicating with said first device and indicating additional data is available for acquisition;
communicating said electronic address to said second device in one or more separate messages in response to one or more corresponding data request messages from said second device, said data request messages being initiated in response to data received from said first device indicating additional data is available for acquisition; and
in response to receiving data indicating said first device electronic address has been acquired by said second device, updating message data for communication to said second device to indicate additional data is unavailable for acquisition.

16. A tangible storage medium incorporating machine readable instructions for performing the activities of claim 15.

17. A system for use in a portable patient monitoring device for monitoring and processing signal parameters acquired from a patient and being suitable for being attached to a docking station, comprising:
an interface processor employed by a portable patient monitoring device for:
receiving first message data identifying a communication protocol to be used in communicating with a docking station, said first message data indicating additional data is available for acquisition,
communicating one or more data request messages to said docking station and receiving from said docking station an electronic address associated with said docking station in one or more separate response messages in response to data received from said docking station indicating additional data is available for acquisition, and
in response to receiving an electronic address, communicating a message to said docking station indicating address data communication is complete.

18. A system according to claim 17 further comprising:
a data acquisition processor for receiving and processing patient parameter data from a plurality of different patient attached sensors to provide processed patient parameter data; and
an display device for displaying processed patient parameter data.

19. A system according to claim 17 wherein said communication interface communicates processed patient parameter data to said docking station when said portable patient monitoring device is attached to said docking station, said processed patient parameter data comprising physiological data including at least one of, (a) electrocardiograph (ECG) data, (b) blood parameter data, (c) ventilation parameter data, (d) infusion pump related data, (e) blood pressure data, (f) pulse rate data and (g) temperature data.

20. A system according to claim 17 wherein said electronic address associated with said particular docking station enables determination of a geographic location of said particular docking station from a map associating said identifier with a corresponding geographic location.

21. A system according to claim 17 wherein said electronic address associated with said particular docking station comprises at least one of, (a) an Ethernet compatible MAC address, (b) an IP address, (c) a port identifier, (d) an Internet compatible address, and (e) a LAN address.

22. A system according to claim 17 wherein said interface processor communicates by at least one of (a) wireless and (b) wired communication.
